(19) United States
(12) Patent Application Publication
(10) Pub. No.: US 2021/0256626 A1
(43) Pub. Date: Aug. 19, 2021

(54) SOCIAL NETWORKING PLATFORM AND METHOD FOR MANAGING THE SAME

(71) Applicant: Vengatesan Kalimuthu, Chennai, TN (US)

(72) Inventors: Vengatesan Kalimuthu, Chennai (IN); Divya Kasturi Rangan, Chennai (IN); Bakkiyamani Bagavathsingh, Chennai (IN)

(73) Assignee: Vengatesan Kalimuthu

(21) Appl. No.: 16/860,284

(22) Filed: Apr. 28, 2020

(30) Foreign Application Priority Data
Feb. 13, 2020 (IN) 202041006231

(51) Int. Cl. G06Q 50/00; G06F 16/9536; H04L 12/58

(52) U.S. Cl. CPC G06Q 50/01; H04L 51/32; G06F 16/9536

(57) ABSTRACT

A social networking platform and method for managing the same is provided. The platform also includes a registration subsystem configured to register one or more entities; a single point interface subsystem configured to provide a single point interface for interaction between the plurality of users and the one or more service providers on the registration subsystem in order to manage one or more services.

### CROSS-REFERENCE TO RELATED APPLICATION

This application claims priority from a patent application filed in India bearing application no. 202041006231, filed on Feb. 13, 2020 and titled “SOCIAL NETWORKING PLATFORM AND METHOD FOR MANAGING THE SAME”.

### FIELD OF INVENTION

Embodiments of the present disclosure relate to a digital platform, and more particularly, to a social networking platform and method for managing the same.

### BACKGROUND

In a traditional family system, people live together as a joint family. Joint family is a family in which members of a unilineal descent group (a group in which descent through either the female or the male line is emphasized) live together with their spouses and offspring in one homestead and under the authority of one of the members. There are lot of advantages of living together in the joint family as it brings a great support system inside the family by reducing differences between the family members based on one or more categories such as physical potential, mental potential, financial potential and the like. However, now a days, people do not like to live in the joint family due to current lifestyle and corporate influence.

Moreover, at present, some systems have been introduced with the solution which provides an individual service with respect to one or more services, wherein the one or more services includes tour and travel services, social services, medical services and the like. For example, in case of doctor's appointment, one must go to different system in order to check status of doctor's arrival and in the same manner, one must go to different system for knowing the progress status of their children. However, the user needs to go to plurality of systems in order to manage one or more services which is a time-consuming process.

Hence there is a need for an improved social networking platform and method for managing the same in order to address the aforementioned issues.

### BRIEF DESCRIPTION

In accordance with an embodiment of the disclosure, a social networking platform is disclosed. The platform includes one or more processors. The platform also includes a registration subsystem operable by the one or more processors. The registration subsystem is configured to register one or more entities, wherein the one or more entities includes a plurality of users and one or more service providers. The platform also includes a single point interface subsystem operable by the one or more processors. The single point interface subsystem is configured to provide a single point interface for interaction between the plurality of users and the one or more service providers on the registration subsystem in order to manage one or more services.

In accordance with another embodiment, a method for managing social networking platform is disclosed. The method includes registering one or more entities, wherein the one or more entities comprises a plurality of users and one or more service providers. The method also includes providing a single point interface for interaction between the plurality of users and the one or more service providers on the registration subsystem in order to manage one or more services.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a social networking platform in accordance with an embodiment of the present disclosure;

FIG. 2 is a block diagram of an embodiment of the social networking platform of FIG. 1 in accordance with an embodiment of the present disclosure;

FIG. 3 is a block diagram of a general computer system in accordance with an embodiment of the present disclosure; and

FIG. 4 is a flow diagram representing steps involved in a method for managing a social networking platform in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a social networking platform and a method for managing the same. The platform includes one or more processors. The platform also includes a registration subsystem operable by the one or more processors. The registration subsystem is configured to register one or more entities, wherein the one or more entities includes a plurality of users and one or more service providers. The platform also includes a single point interface subsystem operable by the one or more processors. The single point interface subsystem is configured to provide a single point interface for interaction between the plurality of users and the one or more service providers on the registration subsystem in order to manage one or more services.

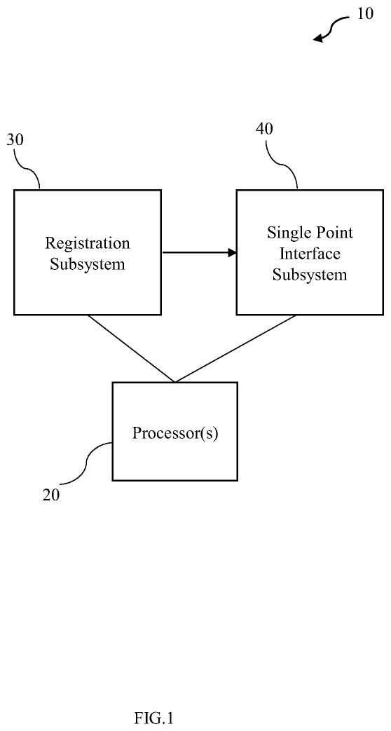

FIG. 1 is a block diagram representation of a social networking platform 10 in accordance with an embodiment of the present disclosure. In one embodiment, the platform 10 may include a centralized platform. The platform 10 includes one or more processors 20. The platform 10 also includes a registration subsystem 30 operable by the one or more processors 20. The registration subsystem 30 registers one or more entities. In one embodiment, the one or more entities may include multiple users and one or more service providers. In such embodiment, the multiple users may include one or more family members, one or more friends and one or more request senders.

In one embodiment, the registration subsystem 30 registers the one or more entities upon receiving one or more details from the one or more entities. In one specific embodiment, the one or more details may include, but not limited to, an entity name, a contact number, an electronic mail address and the like. In one exemplary embodiment, the one or more entities may register with the platform via a computing device such as a hand-held device or a portable device. In such embodiment, the computing device may be one of a mobile phone, a laptop, a tablet and a desktop.

In one specific embodiment, the platform 10 may include a network connection subsystem operable by the one or more processors 20. The network connection subsystem sends a network joining request to the one or more family members and the one or more friends to become a part of a family upon receiving instruction from the one or more request senders. Further, the network connection subsystem creates a relationship network among the one or more request senders, the one or more family members and the one or more friends upon accepting the network joining request by the one or more family members and the one or more friends. In another embodiment, the one or more family members and the one or more friends may send the network joining request to the one or more request senders to add them as a member of the family in the relationship network.

Further, in one specific embodiment, the platform 10 may also include a memory creation subsystem operable by the one or more processors 20. The memory creation subsystem enables the multiple users to create memory in a memory creation module on the platform by adding one or more memorable images or videos associated with life of each of the multiple users. In such embodiment, the multiple users may add the one or more memorable images or videos with a voice over and a text using a predefined template title on the memory creation module.

In one embodiment, a first user of the multiple users may provide access to at least one of the multiple users to view one or more added memorable images or videos along with the voice over and text. In one specific embodiment, the platform 10 also provides facility to the first user of the multiple users to exchange their unforgettable memories with a second user of the multiple users.

Furthermore, in one specific embodiment, the platform 10 may include a task assignment subsystem operable by the one or more processors 20. The task assignment subsystem assigns at least one task to at least one of the multiple users to complete the task within a predefined interval of time. In one embodiment, the at least one task is assigned by selecting the at least one task from one or more predefined tasks in a template.

Further, in one alternative embodiment, the task assignment subsystem enables at least one of the multiple users to update status of at least one completed task on a daily basis. Furthermore, retrospection of the at least one completed task may be performed in order to give one or more rewards to the at least one of the multiple users. In one embodiment, the task assignment subsystem indicates one or more pending tasks to be completed by the at least one of the multiple users on a calendar.

In one specific embodiment, the platform 10 may include a communication subsystem operable by the one or more processors 20. The communication subsystem enables the multiple users to communicate with each other by posting one or more suggestions or one or more queries on the platform. In one embodiment, the at least one user of the multiple users may delegate the query to at least one of the family members or the friend to get responses for the queries.

In some embodiment, the platform 10 may include an information sharing subsystem operable by the one or more processors 20. The information sharing subsystem enables the multiple users to share information on a newsfeed module. In such embodiment, the information may be in any format such as image, video, text, and the like. In one embodiment, the information may include posts, blogs, micro blogs and the like. Further, the information sharing subsystem automatically restricts an unauthenticated or an unauthorized information from sharing with the multiple users on the platform.

Also, the multiple users restrict some information from propagating to children by selecting an option ‘Don't share to children’. The information sharing subsystem also enables the multiple users to restrict one or more viewers of the multiple users from sharing and commenting on the posts.

In one embodiment, the platform 10 may include an event creation subsystem operable by the one or more processors 20. The event creation subsystem creates one or more events by the multiple users in a calendar. Also, the event creation subsystem reminds the at least one of the multiple users about the one or more events associated with any one of the multiple users. In such embodiment, the one or more events may include birthdays, anniversaries, and the like.

Further, the system 10 includes a single point interface subsystem 40 operable by the one or more processors 20. The single point interface subsystem 40 provides a single point interface for interaction between the plurality of users and the one or more service providers on the registration subsystem in order to manage one or more services.

In one embodiment, the one or more services may include, but not limited to, tour and travel services such as coordinating with local tour and travel agencies, social services, local services, medical services such as patient-doctor interaction or patient-clinic interaction, latest news presenting services, business related services, retail services, digital payment services, educational services such as parent-teacher interaction or parent school interaction, event management services such as communicating with event management entities, maintenance related services such as community maintenance platform for fixing technical problems within the communities, wherein the communities may be home, office or any other place, banking services includes interactions with micro-finance institutions, pet care services, property buying or property renting services, food order and delivery services, private transportation booking services, job search portal, searching and subscribing entities registered on the platform and the like.

In one specific embodiment, the single point interface subsystem 40 provides an interface to one or more educational institutions to manage one or more operations associated with classes, institution staffs, calendar, timetable, fees management, leaves management, admissions and the like. Also, the one or more educational institution interfaces enable one or more parents of the multiple users to communicate with one or more educational institutions and one or more teachers of the corresponding one or more educational institutions.

Further, in another embodiment, the single point interface subsystem 40 provides an interface to healthcare management to manage the one or more operations associated with one or more patients, one or more dealers, one or more services, one or more appointments, one or more complaints, one or more requests and the like. Further, in one exemplary embodiment, the healthcare management interface may include a physio module and a user health record module. The physio module creates a clinic, assign doctors, book time slots, patient queuing configuration and the like to facilitate a seamless treatment. The user health record module books an appointment and monitors the doctor's arrival and queue status.

Furthermore, in one specific embodiment, the single point interface subsystem 40 provides an interface to business management to manage the one or more operations associated with one or more customers, one or more dealers, one or more services, one or more appointments and the like. Further, in one exemplary embodiment, the business management interface may include a business module and a consumer module. The business module enables the multiple users to create a business and enables one or more settings to deal with the customers. The consumer module enables the multiple users to book a service time, receive service token and the like via the platform.

Further, the single point interface subsystem 40 provides an interface to banking management to manage micro finance, banking entity and the one or more customers. In one exemplary embodiment, the banking management interface may include a banker module and a consumer module. The banker module enables the multiple users to create a banker business and one or more settings to deal with the customers. The consumer module enables the multiple customers to deal with the banker via the platform.

Similarly, the single point interface subsystem 40 provides an interface to tour and travel management in order to manage the one or more operations associated with the long-distance travel, one day picnic, international tour, casual meeting with friends and the like.

Further, the single point interface subsystem 40 provides an interface to social service management in order to organize and spread the social service activities of the multiple users with non-governmental organization (NGO)s, blood banks and one or more service-oriented entities. In one embodiment, the single point interface subsystem 40 also provides the interface to enable the multiple users to interact with leaders, mentors or social icons to inspire the multiple users by spreading their ideologies with a multimedia.

Furthermore, in one specific embodiment, the single point interface subsystem 40 provides an interface to digital payment management in order to make payment for the one or more services availed by the multiple users on the platform. In addition, the single point interface subsystem 40 also caters third party bill payment services such as electricity bill, telephone bill, internet bills, credit card bills and the like.

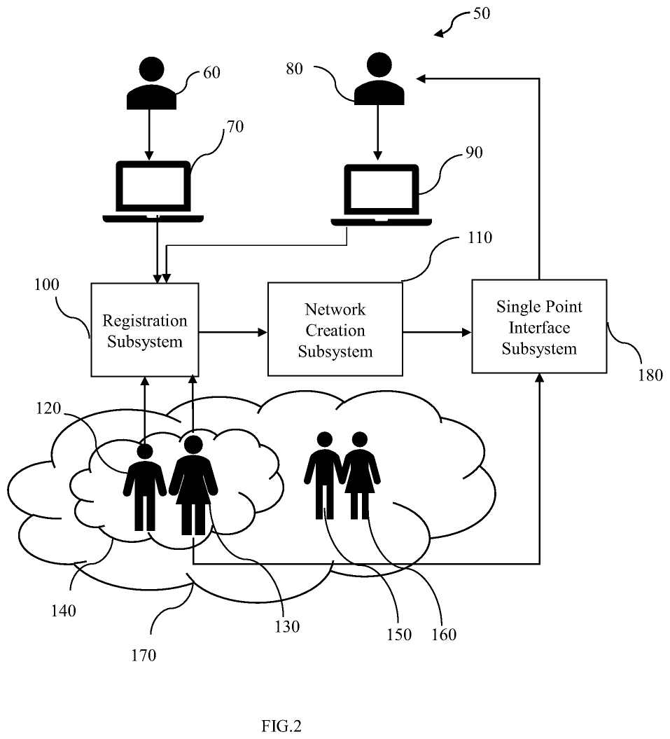

FIG. 2 is a block diagram of an embodiment of the social networking platform 50 of FIG. 1 in accordance with an embodiment of the present disclosure. A user ‘X’ 60 registers on a platform by a registration subsystem 100 through a laptop 70 by providing a plurality of user details including a username, a contact number and an electronic mail address. Also, a service provider ‘P’ 80 registers on the platform, by the registration subsystem 100, through a laptop 90 by providing a plurality of service provider details including one or more services provided by the corresponding service provider.

Further, upon registration of the user ‘X’ 60 on the platform, the user ‘X’ 60 invites one or more family members such as ‘Y’ 120 and ‘Z’ 130, by a network creation subsystem 110, to join a family group 140 by registering on the platform. Once the family group 140 is formed, the user ‘X’ 60 invites one or more friends such as ‘A’ 150 and ‘B’ 160 to become a member of the family by the network creation subsystem 110, which in turn creates a joint family 170 by registering on the platform.

Moreover, the platform provides a single point interface subsystem 180 for interaction between at least one member of joint family and the one or more service providers on the registration subsystem 100 in order to manage one or more services. For example, ‘Z’ 130 is a parent of ‘Y’ 120 and wants to know a study progress report of the child ‘Y’ 120. The single point interface subsystem 180 provides a school interface on the platform to enable the parent ‘Z’ 130 to interact with a teacher ‘T’ 80 of the one or more service providers to get the progress report of the child ‘Y’ 120. Also, the parent ‘Z’ 130 will take appointment from the teacher ‘T’ 80 to meet the teacher ‘T’ 80 via the platform. Accordingly, the centralized platform reduces the waiting time of the user by avoiding long queues. Furthermore, the registration subsystem 100 and the single point interface subsystem 180 are substantially similar to a registration subsystem 30 and a single point interface subsystem 40 of FIG. 1.

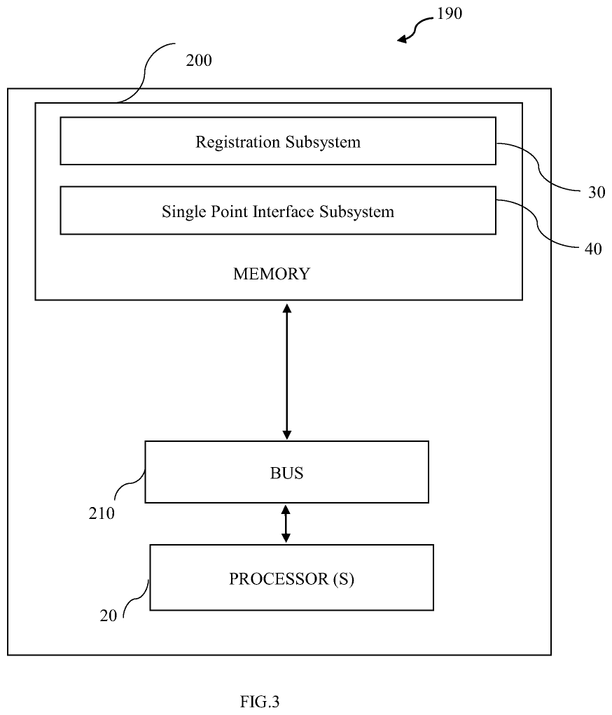

FIG. 3 is a block diagram of a general computer system 190 in accordance with an embodiment of the present disclosure. The computer system 190 includes processor(s) 20, and memory 200 coupled to the processor(s) 20 via a bus 210. The processor(s) 20, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 200 includes a plurality of subsystems stored in the form of executable program which instructs the processor 20 to perform the configuration of the system illustrated in FIG. 3. The memory 200 has following subsystems: a registration subsystem 30 and a single point interface subsystem 40 of FIG. 1.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 20.

The registration subsystem 30 instructs the processor(s) 20 to one or more entities, wherein the one or more entities comprises a plurality of users and one or more service providers. The single point interface subsystem 40 instructs the processor(s) 20 to provide a single point interface for interaction between the plurality of users and the one or more service providers on the registration subsystem in order to manage one or more services.

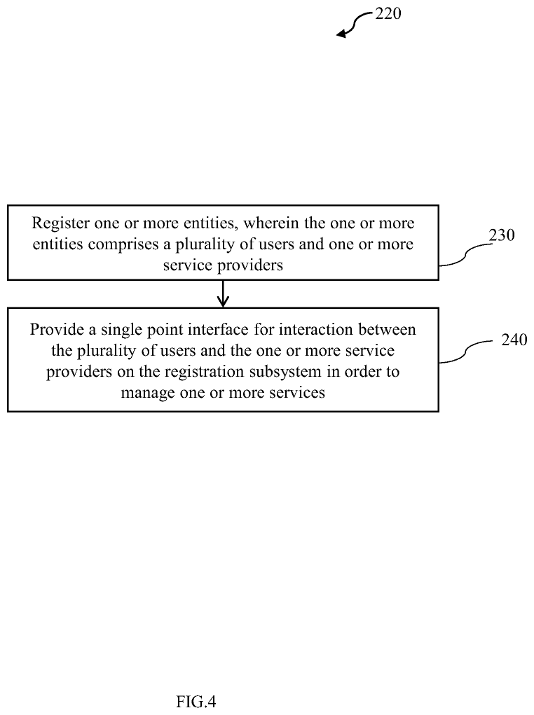

FIG. 4 is a flow diagram representing steps involved in a method 220 for managing a social networking platform in accordance with an embodiment of the present disclosure. The method 220 includes registering, by a registration subsystem, one or more entities in step 230. In one embodiment, registering the one or more entities may include registering multiple users and one or more service providers. Further, in such embodiment, registering the multiple users may include registering one or more friends and one or more request senders.

In one embodiment, registering the one or more entities may include registering the one or more entities upon receiving one or more details from the one or more entities. In one specific embodiment, registering the one or more entities upon receiving the one or more details may include registering the one or more entities upon receiving an entity name, a contact number, an electronic mail address and the like from the one or more entities.

In one exemplary embodiment, registering the one or more entities with the platform may include registering the one or more entities with the platform via a computing device such as a hand-held device or a portable device. In such embodiment, registering the one or more entities with the platform via the computing device may include registering the one or more entities with the platform via one of a mobile phone, a laptop, a tablet and a desktop.

In one specific embodiment, the method 220 may include sending, by a network connection subsystem, a network joining request to the one or more family members and the one or more friends to become a part of a family upon receiving instruction from the one or more request senders. Further, the method 220 may include creating, by the network connection subsystem, a relationship network among the one or more request senders, the one or more family members and the one or more friends upon accepting the network joining request by the one or more family members and the one or more friends.

In another embodiment, the method 220 may include sending the network joining request by the one or more family members and the one or more to the one or more request senders to add them as a member of the family in the relationship network. Further, in one embodiment, the method 220 may include enabling, by a memory creation subsystem, the multiple users to create memory in a memory creation module on the platform by adding one or more memorable images or videos associated with life of each of the multiple users.

In some embodiment, the method 220 may include providing, by the memory creation subsystem, access to at least one of the multiple users by a first user of the multiple users to view one or more added memorable images or videos along with the voice over and text. In one specific embodiment, the method 220 may include assigning, by a task assignment subsystem, at least one task to at least one of the multiple users to complete the task within a predefined interval of time, wherein the at least one task is assigned by selecting the at least one task from one or more predefined tasks in a template.

Furthermore, in an alternative embodiment, the method 220 may include enabling, by the task assignment subsystem, at least one of the multiple users to update status of at least one completed task on a daily basis. Then, the method 220 may also include indicating, by the task assignment subsystem, one or more pending tasks to be completed by the at least one of the multiple users on a calendar.

In one embodiment, the method 220 may include enabling, by a communication subsystem, the multiple users to communicate with each other by posting one or more suggestions or one or more queries on the platform. Further, the method 220 may include delegating the query to at least one of the family member or the friend by the at least one user of the multiple users to get responses for the queries.

In some embodiment, the method 220 may include enabling, by an information sharing subsystem, the multiple users to share information on a newsfeed module. In such embodiment, enabling the multiple users to share the information may include enabling the multiple users to share any post, blogs, micro blogs and the like on the newsfeed module. Further, the method 220 may include restricting, by the information sharing subsystem, an unauthenticated or an unauthorized information from sharing with the multiple users on the platform.

In one embodiment, the method 220 may include creating, by an event creation subsystem, one or more events by the multiple users in a calendar. Further, the method 220 may also include reminding, by the event creation subsystem, the at least one of the multiple users about the one or more events associated with any one of the multiple users.

The method 220 also includes providing, by a single point interface subsystem, a single point interface for interaction between the plurality of users and the one or more service providers on the registration subsystem in order to manage one or more services in step 240. In one embodiment, managing the one or more services may include managing tour and travel services, social services, local services, medical services, business related services, retail services and the like.

In one specific embodiment, the method 220 may include providing, by the single point interface subsystem, an interface to one or more educational institutions to manage one or more operations associated with classes, institution staffs, calendar, timetable, fees management, leaves management, admissions and the like. Also, the method 220 may include enabling, by one or more educational institution interfaces, one or more parents of the multiple users to communicate with one or more educational institutions and one or more teachers of the corresponding one or more educational institutions.

The method 220 may also include providing, by the single point interface subsystem, an interface to healthcare management to manage the one or more operations associated with one or more patients, one or more dealers, one or more services, one or more appointments, one or more complaints, one or more requests and the like. Further, the method 220 may also include providing, by the single point interface subsystem, an interface to business management to manage the one or more operations associated with one or more customers, one or more dealers, one or more services, one or more appointments and the like.

Moreover, the method 220 may include providing, by the single point interface subsystem, an interface to banking management to manage micro finance, banking entity and the one or more customer. In addition, the method 220 may include providing, by the single point interface subsystem, an interface to tour and travel management in order to manage the one or more operations associated with the long-distance travel. one day picnic, international tour, casual meeting with friends and the like.

Further, the method 220 may also include providing, by the single point interface subsystem, an interface to social service management in order to organize and spread the social service activities of the multiple users with non-governmental organization (NGO)s, blood banks and one or more service-oriented entities. In one embodiment, the method 220 may also include providing, by the single point interface subsystem, the interface to enable the multiple users to interact with leaders, mentors or social icons to inspire the multiple users by spreading their ideologies with multimedia.

Various embodiments of the system provide a technical solution to the problem of social networking platform. The present disclosure provides an efficient centralized platform which helps user to enrich or strengthen relationship between the family members by creating a virtual joint family. Also, the present disclosure facilitates sharing suggestions, pointers, recommendations for personal or general queries arosed by the people. Moreover, the platform helps the user to create a digital platform for customer service for their business ranging from small and micro scale up to big supermarkets. In addition, the present disclosure helps the patients to avoid waiting in queues by getting updates about the doctor's arrival and patients' queue status which in turn saves time of the user.

The present disclosure provides a secured platform, where the accessibility pattern to the platform changes once in 15 minutes and only the user from his registered device will be able to access authorized pages and one or more utilities. Also, the present disclosure provides a security by generating an encrypted random identification for the user and the password which in turn reduces the possibility of breaching the security to access the information associated with the family members. Moreover, the user can access from only one device at a time and if the user will try to register from non-registered devices, then the user needs to face one or more problems.

Further, the platform will generate an alert if the amount of time spent by the user on the social media exceeds and request the user to spend time with the family. Also, the family head in the group can set a stipulated time to access the platform for himself and others in the family group. Moreover, the present platform does not allow a fake user or a fake family to propagate the malicious content on the platform. In addition, the present disclosure enables the user to restrict the user to share malicious content by virtue on the platform. Further, the present disclosure provides a monitoring facility to the parents to monitor the children on the platform.

The present disclosure also provides a feature which helps to support the parents emotionally and morally when they need support in their old age. The system also provides facilitates for the elderly people to bring the confidence that they are backed by their children.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A social networking platform comprising:
one or more processors;
a registration subsystem operable by the one or more processors, wherein the registration subsystem is configured to register one or more entities, wherein the one or more entities comprises a plurality of users and one or more service providers; and
a single point interface subsystem operable by the one or more processors, wherein the single point interface subsystem is configured to provide a single point interface for interaction between the plurality of users and the one or more service providers on the registration subsystem in order to manage one or more services.

2. The platform as claimed in claim 1, wherein the one or more services comprise tour and travel services, social services, local services, medical services, business related services and retail services.

3. The platform as claimed in claim 1, comprising a network creation subsystem configured to create a relationship network between the plurality of users.

4. The platform as claimed in the claim 1, comprising a task assignment subsystem configured to assign a task to the plurality of users to complete the task within a predefined interval of time.

5. The platform as claimed in the claim 1, comprising a communication subsystem configured to enable the plurality of users to communicate by posting one or more queries.

6. The platform as claimed in claim 1, comprising an event creation subsystem configured to create one or more events by the plurality of users in a calendar.

7. The platform as claimed in claim 1, comprising a memory creation subsystem configured to enable the plurality of users to create one or more memories by adding one or more images or videos associated with life of each of the plurality of users.

8. A method for managing a social networking platform comprising:
registering, by a registration subsystem, one or more entities, wherein the one or more entities comprise a plurality of users and one or more service providers; and
providing, by a single point interface subsystem, a single point interface for interaction between the plurality of users and the one or more service providers on the registration subsystem in order to manage one or more services.

9. The method as claimed in claim 8, wherein managing the one or more services comprises managing at least one of tour and travel services, social services, local services, medical services, business related services and retail services.

10. The method as claimed in claim 8, comprising creating, by a network creation subsystem, a relationship network between the plurality of users.
